(19) United States
(12) Patent Application Publication
(10) Pub. No.: US 2009/0273942 A1
(43) Pub. Date: Nov. 5, 2009

(54) HEADLIGHT ASSEMBLY WITH CONFIGURABLE INDICATOR ARRAY

(76) Inventors: CLAUDIO R. BALLARD, HUNTINGTON, NY (US); GARY FULKERSON, WHITE LAKE, MI (US); JEFF SEWARD, FAIRFAX, VT (US)

Correspondence Address: HOWISON & ARNOTT, L.L.P, P.O. BOX 741715, DALLAS, TX, 75374-1715, US

(21) Appl. No.: 12/395,635

(22) Filed: Feb. 28, 2009

Related U.S. Application Data
(60) Provisional application No. 61/034,471, filed on Mar. 6, 2008.

(51) Int. Cl. F21V 7/00; B60Q 1/00

(52) U.S. Cl. 362/516; 362/538

(57) ABSTRACT

The present disclosure provides a headlight assembly comprising a configurable indicator array that includes a plurality of individually controllable lights that may be activated and deactivated to form a plurality of light patterns.

### CROSS-REFERENCE TO RELATED APPLICATIONS

This application claims the benefit of U.S. Provisional Application for Patent Ser. No. 61/034,471, filed Mar. 6, 2008, and entitled HEADLIGHT ASSEMBLY WITH CONFIGURABLE INDICATOR ARRAY, the specification of which is incorporated herein in its entirety by reference.

### TECHNICAL FIELD

The following disclosure relates to vehicle lighting and, more particularly, to a vehicle headlight assembly having a configurable indicator array.

### BACKGROUND

It is well known to use one or more headlights to illuminate the path of a vehicle such as a motorcycle, automobile, truck, boat, or aircraft to provide forward visibility to an operator of the vehicle. It is also well known to use indicator lights to provide an indication of various maneuvers that are to be performed or are being performed, such as signaling a left or right turn. However, headlights and other signaling and/or illumination lights are typically special purpose lights that are designed to perform a fixed lighting function. Therefore, a need exists for a vehicle lighting solution that provides flexibility in the delivery of illumination and signaling.

### SUMMARY

In one embodiment, the present disclosure provides a headlight assembly comprising a support structure, a projection light, and a configurable indicator array. The support structure has a back side, a left side, a right side, a top side, and a bottom side defining a cavity. An opening of the cavity is on a front side of the support structure. The support structure also has first and second supports positioned at least partially within the cavity. The projection light is retained in the support structure at least in part by the first support. The configurable indicator array is retained in the support structure at least in part by the second support and includes a plurality of individually controllable lights that may be activated and deactivated to form a plurality of light patterns.

In another embodiment, the present disclosure provides a configurable headlight indicator system comprising a cover and a configurable indicator array. The cover has first and second sides and includes a reflective translucent portion that at least partially reflects external light striking the first side. The configurable indicator array has a plurality of individually controllable lights positioned on the second side of the cover and oriented to shine through the second and first sides of the cover. The configurable headlight indicator system also includes means for activating and deactivating the individually controllable lights in order to create one of a plurality of programmed patterns representing a visual indicator.

In yet another embodiment, the present disclosure provides a configurable headlight indicator system comprising a support structure, a projection light, a cover, a light emitting diode (LED) array, and a controller. The support structure has a cavity defined therein and first and second supports positioned at least partially within the cavity. The projection light is retained in the support structure at least in part by the first support. The cover has first and second sides, and at least partially reflects external light striking the first side. The cover is positioned over the cavity with the second side facing the cavity. The LED array has a plurality of individually controllable LEDs positioned at least partially within the cavity and retained at least in part by the second support. The LED array is oriented to shine through the second and first sides of the cover. The controller is configured to activate and deactivate the individually controllable LEDs to create one of a plurality of programmed patterns representing a visual indicator.

### BRIEF DESCRIPTION OF THE DRAWINGS

For a more complete understanding, reference is now made to the following description taken in conjunction with the accompanying Drawings in which:

FIG. 1 illustrates a solid model perspective view of a headlight assembly in accordance with one embodiment of the present disclosure;

FIG. 2 illustrates a solid model perspective view of one embodiment of a cover that may be used in the headlight assembly of FIG. 1;

FIG. 3 illustrates a solid model perspective view of one embodiment of a tub that may be used in the headlight assembly of FIG. 1;

FIGS. 4a and 4b illustrate solid model and wireframe front views, respectively, of one embodiment of a bezel that may be used in the headlight assembly of FIG. 1;

FIGS. 5a and 5b illustrate solid model front and top views, respectively, of the bezel of FIGS. 4a and 4b;

FIGS. 6a and 6b illustrate solid model and wireframe side cross-sectional views, respectively, of one embodiment of the headlight assembly of FIG. 1;

FIG. 7 illustrates a wireframe front view of one embodiment of the headlight assembly of FIG. 1;

FIG. 8 illustrates a wireframe perspective view of one embodiment of the headlight assembly of FIG. 1;

FIG. 9 illustrates a solid model top cross-sectional view of one embodiment of the headlight assembly of FIG. 1;

FIGS. 10a and 10b illustrate solid model and wireframe front cross-sectional views, respectively, of one embodiment of the headlight assembly of FIG. 1;

FIGS. 11a-11d illustrate embodiments of a configurable indicator array that may be used in the headlight assembly of FIG. 1, wherein:

FIG. 11a is a top view of one embodiment;

FIG. 11b is a perspective view of one embodiment;

FIG. 11c is a side view of one embodiment; and

FIG. 11d is a side view of another embodiment;

FIG. 12 illustrates a diagrammatic view of one embodiment of a system that may be used in conjunction with various components of the headlight assembly of FIG. 1; and

FIGS. 13a and 13b illustrate perspective and front views of one embodiment of a vehicle with the headlight assembly of FIG. 1.

### DETAILED DESCRIPTION

Referring now to the drawings, wherein like reference numbers are used herein to designate like elements throughout, the various views and embodiments of a headlight assembly with configurable indicator array. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

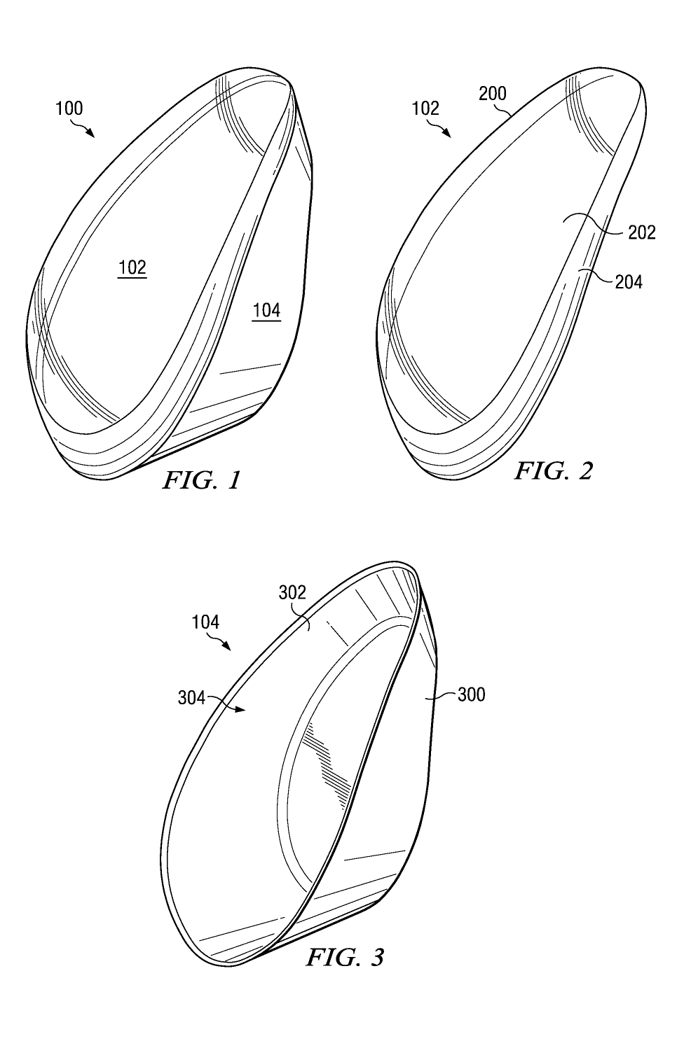

Referring to FIG. 1, one embodiment of a headlight assembly 100 is illustrated. The headlight assembly 100 includes a transparent/translucent cover 102 and a tub 104, which may be transparent, translucent, or opaque. The headlight assembly 100 may be designed to fit at least partially into a cavity in a vehicle.

With additional reference to FIG. 2, one embodiment of the cover 102 of FIG. 1 is illustrated with an exterior surface 200. The cover 102 may be curved outwardly (i.e., the exterior surface 200 may be convex) and may have a relatively uniform thickness. It is understood that the curvature, thickness, transparency/translucency, and other properties of the cover 102 may vary and that such properties may be different in different areas of the cover. In the present example, the cover 102 includes a transparent portion 202 and a translucent colored portion 204 that extends partially around an edge of the cover 102. Some or all of an exterior surface of the translucent colored portion 204 may be reflective with respect to external light. For example, the exterior surface of the translucent colored portion 204 may have a reflective coating or may have reflective structures integrated therein. Furthermore, while the cover 102 is illustrated as being a single piece of material in the present example, it is understood that it may be composed of multiple pieces.

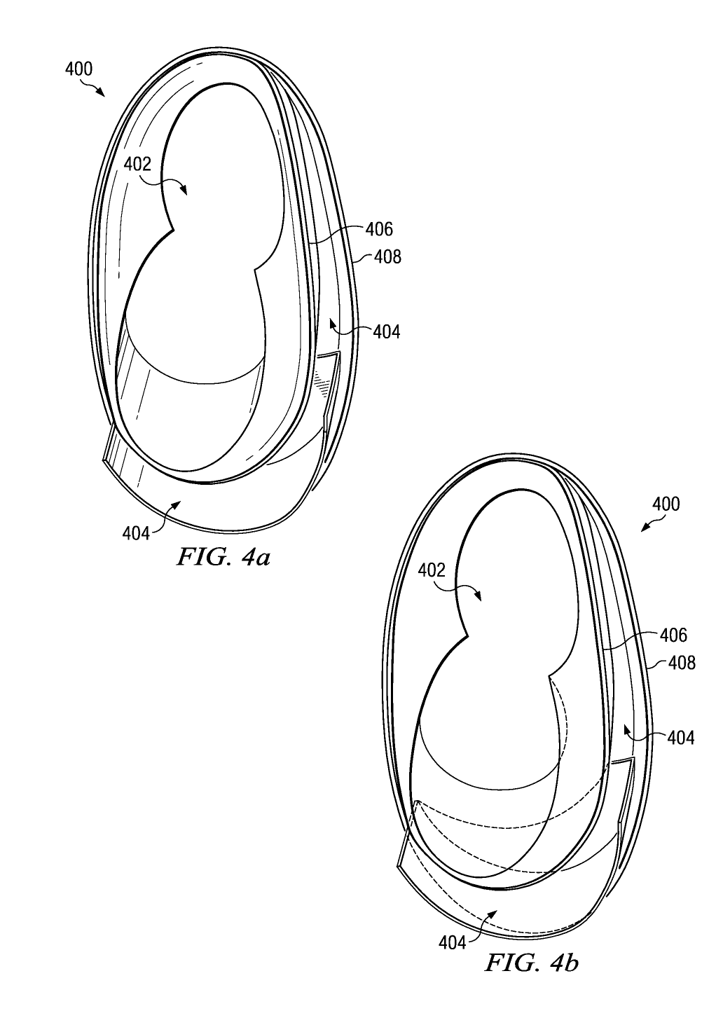

With additional reference to FIG. 3, one embodiment of the tub 104 of FIG. 1 is illustrated with an exterior surface 300 and an interior surface 302 defining a cavity 304. The cavity 304 may be identical in size or smaller than the cover 102 so that the cavity 304 is protected by the cover when the cover is in place. The tub 104 may include one or more coupling points or mounting features (not shown) that may be used to attach the tub to a vehicle. It is understood that the curvature, thickness, and other properties of the tub 104 may vary and that such properties may be different in different areas of the tub.

Referring to FIGS. 4a and 4b, one embodiment of a bezel 400 that may be used in the headlight assembly 100 of FIG. 1 is illustrated in solid model and wireframe views, respectively. The bezel 400 may be sized to fit within the cavity 304 of the tub 104 and provides support for lights, light assemblies, and light arrays, as will be described later in greater detail. In the present example, the bezel 400 includes an aperture 402 configured to receive two light assemblies (not shown). A channel 404 formed by walls 406 and 408 extends around a portion of an exterior edge of the bezel 400. In the present example, one end of the channel 404 is open, but it is understood that either end may be open or closed in a particular embodiment of the bezel 400. It is noted that a lower portion of the wall 406 may merge with or form a shelf for a light assembly.

When the headlight assembly 100 is in an assembled state, the location of the channel 404 may correspond approximately to the location of the translucent colored portion 204 of the cover 102. In other words, the channel 404 may be partially or entirely positioned behind the translucent colored portion 204. The bezel 400 may include one or more coupling points or mounting features (not shown) that may be used to attach the bezel to the tub 104 or to another portion of a vehicle. It is understood that the curvature, thickness, aperture and channel dimensions, and other properties of the bezel 400 may vary and that such properties may be different in different areas of the bezel.

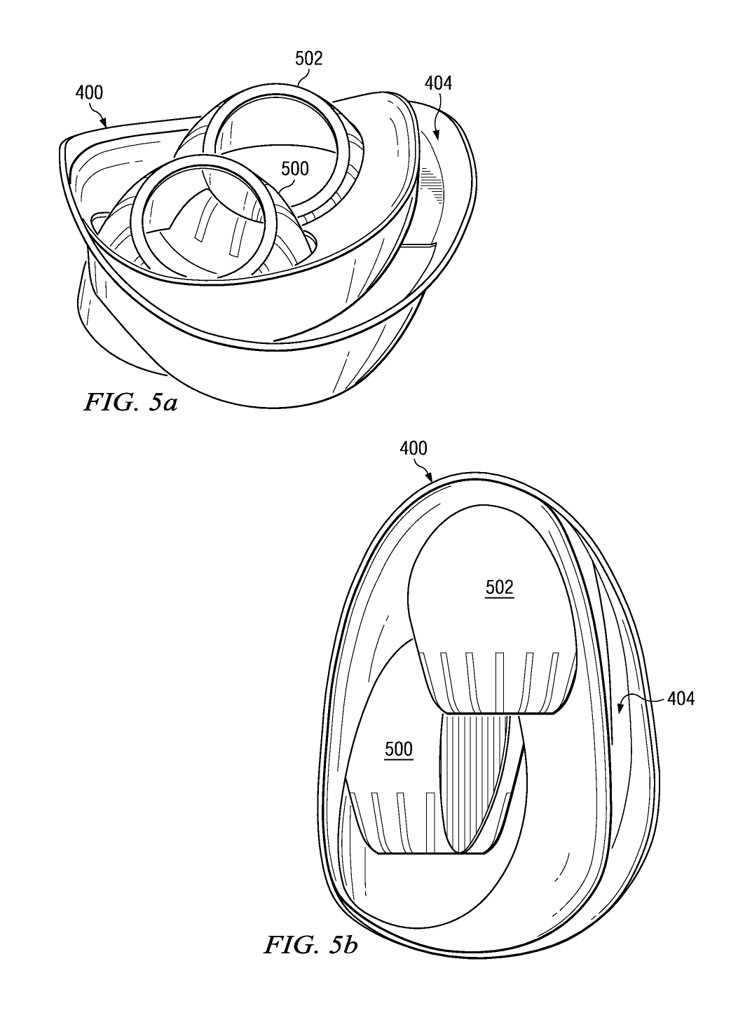

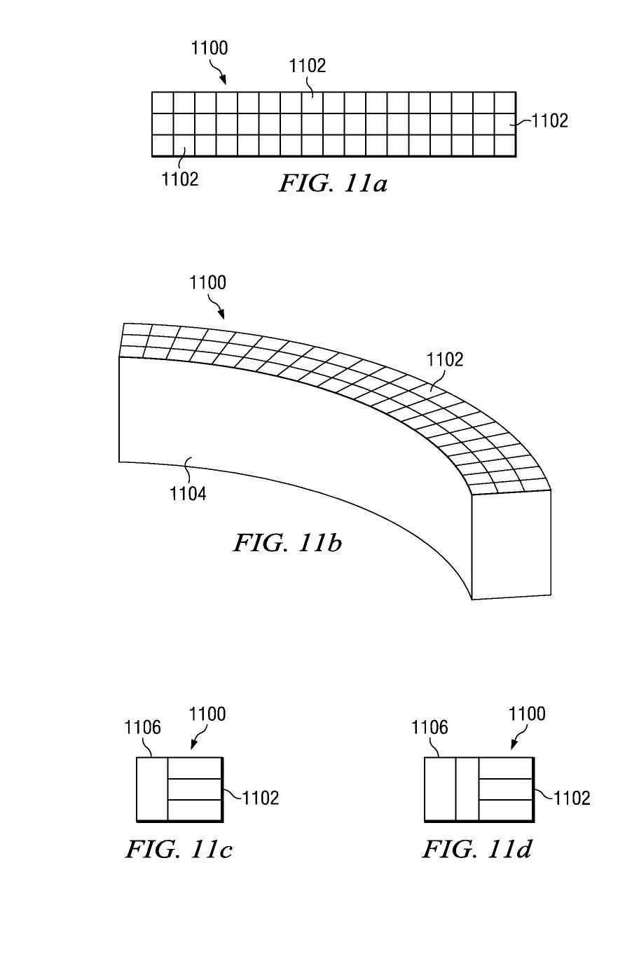

With additional reference to FIGS. 5a and 5b, the bezel 400 of FIGS. 4a and 4b is illustrated with two projection light covers 500 and 502 positioned in the aperture 402 (not shown) in a relatively forward facing position. The projection light covers 500 and 502 may contain, for example, Xenon projection lights, although any type of suitable illumination source may be used, including light emitting diodes (LEDs). In the present example, the projection lights are single color (e.g., white), but other colors or combinations of colors may be used. A configurable indicator array (described below with respect to FIGS. 11a-11d) that includes multiple lights that are controllable via a computer may be positioned within the channel 404.

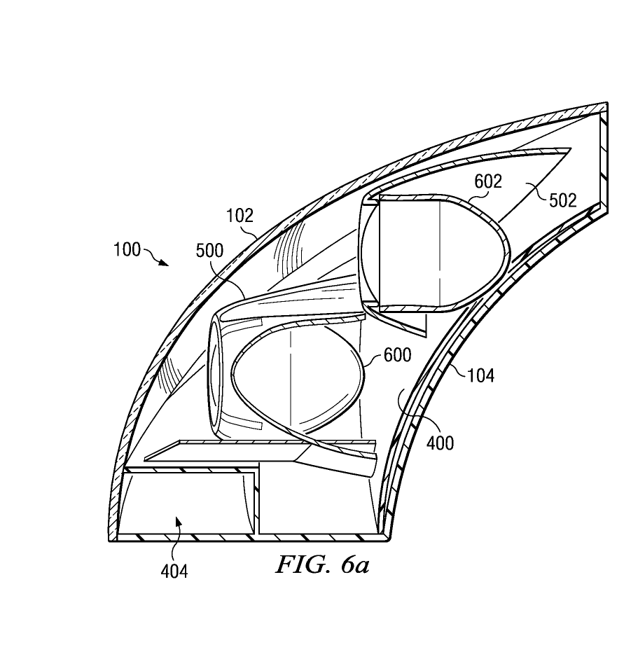

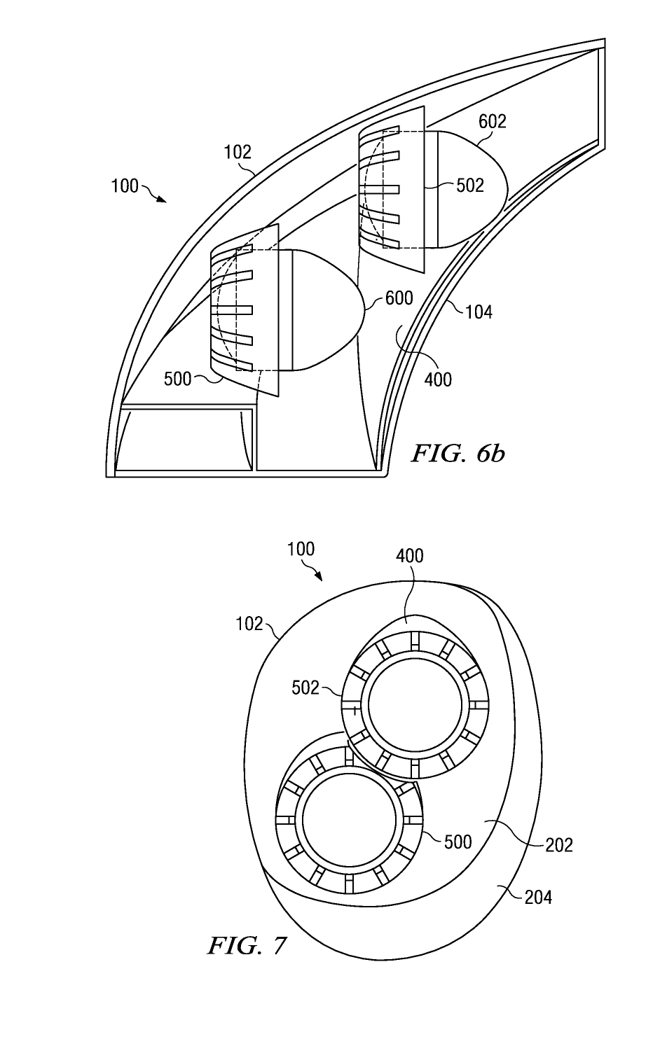

With additional reference to FIGS. 6a and 6b, one embodiment of the headlight assembly 100 of FIG. 1 is illustrated in solid model and wireframe views, respectively. The projection light covers 500 and 502 include projection lights 600 and 602, respectively, both of which are positioned within bezel 400. Bezel 400 is secured in tub 104 and covered by cover 102. The lower portion of channel 404 extends below projection light cover 500 and corresponding projection light 600.

Referring to FIG. 7, one embodiment of the headlight assembly 100 of FIG. 1 is illustrated in a front wireframe view. The cover 102 illustrates the positioning of transparent portion 202 and translucent colored portion 204 with respect to the projection light covers 500 and 502.

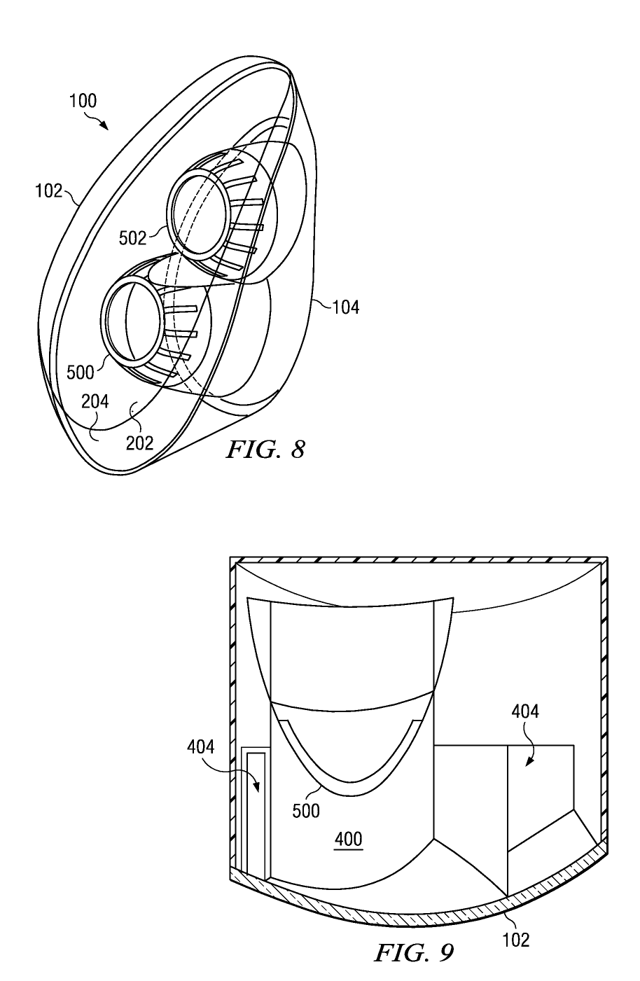

Referring to FIG. 8, one embodiment of the headlight assembly 100 of FIG. 1 is illustrated in a perspective wireframe view. The cover 102 illustrates the positioning of transparent portion 202 and translucent colored portion 204 with respect to the projection light covers 500 and 502.

Referring to FIG. 9, one embodiment of the headlight assembly 100 of FIG. 1 is illustrated in a solid model cross-sectional top view. A lower portion of projection light cover 500 is visible and is positioned behind cover 102. Channel 404 wraps underneath bezel 400 adjacent to cover 102 and is visible on both sides of the bezel. As illustrated in the current view, channel 404 may have varied dimensions.

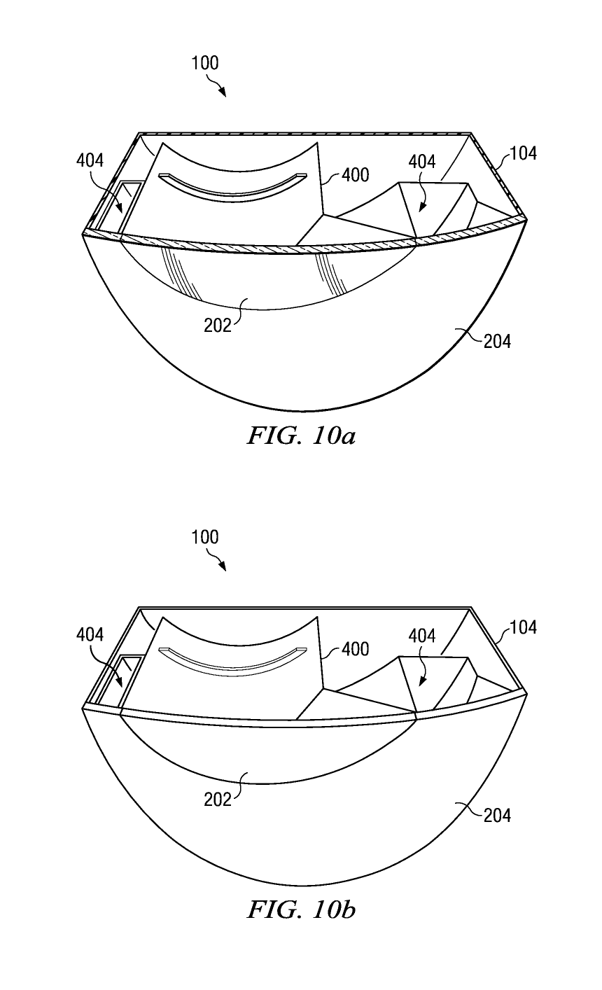

Referring to FIGS. 10a and 10b, one embodiment of the headlight assembly 100 of FIG. 1 is illustrated in solid model and wireframe cross-sectional front views, respectively. Part of the transparent portion 202 and the lower area of the translucent colored portion 204 are positioned in front of bezel 400. Channel 404 is visible and, as stated previously, may correspond in shape to the translucent colored portion 204 (i.e., the location of the unseen portion of the channel 404 in FIG. 10a may be at least approximately represented by the translucent colored portion 204).

Referring to FIGS. 11a-11d, a configurable indicator array 1100 may include multiple lights 1102. For purposes of convenience, the disclosure will refer to the configurable indicator array 1100 as using LEDs, but it is understood that any type of light source may be used. Although shown as a single array, it is understood that the configurable indicator array 1100 may include multiple arrays. The LEDs 1102 may be individually controllable and packaged in such a manner as to fit within the channel 404 facing outward (i.e., towards the cover 102). The LEDs in the configurable indicator array 1100 may be arranged in various M x N relationships, where M and N are greater than or equal to one (although gaps in the array may exist where no LED is present). Different LEDs may emit different wavelengths of light, and so the configurable indicator array 1100 may emit light of a single color or of different colors. The LEDs may be packaged individually or may be packaged in groups, such as in a tri-color red-green-blue (RGB) LED package. Furthermore, the arrangement of the LEDs in the configurable indicator array 1100 may vary, and the array itself may be arranged in various configurations (e.g., straight or curved). For example, FIG. 11a illustrates a rectangular 3×N LED array 1100, where N=17. The values of M and N may be selected so as to fit within the channel 404. In another example, FIG. 11b illustrates a curved 3×N LED array 1100.

It is understood that the configurable indicator array 1100 may include an exterior surface 1104 (FIG. 11b) that provides support to the array but, in some embodiments, may also be somewhat flexible to allow the array to be positioned within the channel 404. In other embodiments, the exterior surface 1104 may be relatively rigid and may be formed to fit within the channel 404 without altering the shape of the array.

As illustrated in FIGS. 11c and 11d, the configurable indicator array 1100 may include a controller 1106, which may be a circuit board or other device providing controllable power to the LEDs 1102. In some embodiments, the controller 1106 may receive a signal from a computer or other controller (not shown) with a relatively simple instruction (e.g., left turn) and the controller may manipulate the corresponding LEDs 1102 to comply with the instruction without further input from the computer. Furthermore, the controller 1106 may store multiple patterns representing different configurations of active/inactive LEDs, and multiple patterns may be executed simultaneously. In other embodiments, the controller 1106 may receive detailed instructions from the computer identifying a pattern or specific LEDs 1102 that are to be activated or deactivated. Other information, such as duration, may be received from the computer.

The controller 1106 may be positioned immediately adjacent to the LEDs 1102 (FIG. 11c) or may be separated from the LEDs (FIG. 11d). Furthermore, the controller 1106 may be separated entirely from the configurable indicator array 1100 and may be positioned elsewhere. In some embodiments, the controller 1106 may include multiple circuit boards or other devices and may be removable.

The configurable indicator array 1100 provides flexibility to the headlight assembly 100. As the LEDs 1102 in the configurable indicator array 1100 may be activated/deactivated as desired, many combinations of lights are possible. For example, if a turn signal is desired, all LEDs in the configurable indicator array 1100 may be activated in a blinking manner. Alternatively, only certain LEDs may be activated. In other examples, all or a portion of the LEDs 1102 may be used as daytime running lights, hazard lights, and for other purposes. Furthermore, as different LEDs of the configurable indicator array 1100 may be controlled individually, multiple functions may be executed simultaneously. For example, a portion of the LEDs may be used for daytime running lights, while another portion may be used as a turn signal when needed. In other embodiments, such as where the translucent colored portion 204 is not colored, different colors of LEDs may be used for different functions (e.g., yellow LEDs for turn signals and white LEDs for running lights). It is understood that LEDs of the configurable indicator array 1100 may be used for illumination purposes to assist or replace projection lights of the headlight assembly 100

In embodiments where the configurable indicator array 1100 provides sufficient resolution (i.e., where M×N are large enough), the configurable indicator array may provide additional functionality. For example, if M×N are sufficiently large, the LEDs may be activated in a pattern representative of an arrow to indicate a turn signal.

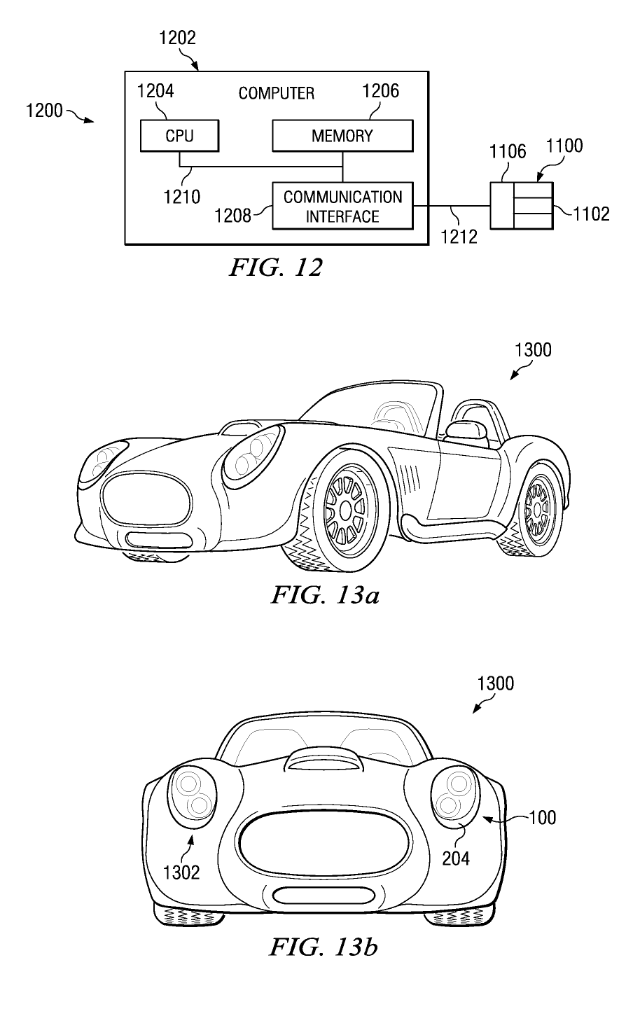

Referring to FIG. 12, one embodiment of a system 1200 that may be used to control all or part of the headlight assembly 100 of FIG. 1 illustrates a computer 1202 coupled to the configurable indicator array 1100 of FIG. 10c. In the present example, the computer 1202 is coupled to the controller 1106, which then activates and deactivates the LEDs 1102. In other embodiments, the computer 1202 may control the LEDs 1102 directly. It is understood that the computer 1202 is representative of any control device that may send control signals to the configurable indicator array 1100. Accordingly, while the computer 1200 is illustrated with a central processing unit (CPU) 1204, memory 1206, and communication interface 1208 (which may be wired or wireless) coupled by one or more control lines 1210 (e.g., a bus), it is understood that many different control systems may be used with the configurable indicator array 1100 and that various components may be distributed. Furthermore, one or more control lines 1212 coupling the computer 1202 to the configurable indicator array 1100 may be wired as shown or may be wireless.

Referring to FIGS. 13a and 13b, one embodiment of a vehicle 1300 illustrates the headlight assembly 100 of FIG. 1 after installation as the front left (i.e., driver's side) headlight assembly. A second headlight assembly 1302, which may be a mirror image of the headlight assembly 100, is installed as the front right headlight assembly. As described above, the configurable indicator array 1100, which is positioned behind the reflective translucent colored portion 204, provides variable lighting depending on its configuration.

It will be appreciated by those skilled in the art having the benefit of this disclosure provides a headlight assembly with configurable indicator array. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A headlight assembly comprising:
a support structure having a back side, a left side, a right side, a top side, and a bottom side defining a cavity, wherein an opening of the cavity is on a front side of the support structure, and first and second supports positioned at least partially within the cavity;
a projection light retained in the support structure at least in part by the first support; and
a configurable indicator array retained in the support structure at least in part by the second support, wherein the configurable indicator array includes a plurality of individually controllable lights that may be activated and deactivated to form a plurality of light patterns.

2. The headlight assembly of claim 1 further comprising a cover having a transparent portion and a reflective translucent portion, wherein the cover is positioned over the opening with the transparent portion located in front of the projection light and the reflective translucent portion located in front of the configurable indicator array.

3. The headlight assembly of claim 2 wherein the reflective translucent portion extends in a band around at least a portion of an outer edge of the cover.

4. The headlight assembly of claim 1 wherein the support structure includes a bezel having the first and second supports formed therein.

5. The headlight assembly of claim 4 wherein the second support is a channel.

6. The headlight assembly of claim 1 wherein the individually controllable lights are light emitting diodes (LEDs).

7. The headlight assembly of claim 6 wherein a wavelength of light emitted by a first one of the LEDs is different than a wavelength of light emitted by a second one of the LEDs in order to provide two colors of light.

8. The headlight assembly of claim 7 wherein the first one of the LEDs emits red light, the second one of the LEDs emits green light, and a third LED emits blue light.

9. The headlight assembly of claim 6 wherein at least a portion of the LEDs emit white light and are positioned behind a tinted covering material.

10. A configurable headlight indicator system comprising:
a cover having first and second sides, wherein the cover includes a reflective translucent portion that at least partially reflects external light striking the first side;
a configurable indicator array having a plurality of individually controllable lights positioned on the second side of the cover and oriented to shine through the second and first sides of the cover; and
means for activating and deactivating the individually controllable lights in order to create one of a plurality of programmed patterns representing a visual indicator.

11. The configurable headlight indicator system of claim 10 wherein the means for activating and deactivating the individually controllable lights is configured to activate at least some of the individually controllable lights to simultaneously create multiple programmed patterns.

12. The configurable headlight indicator system of claim 10 wherein the means for activating and deactivating includes at least one controller coupled to the configurable indicator array.

13. The configurable headlight indicator system of claim 12 further comprising a computer coupled to the at least one controller, wherein the at least one controller is configured to receive an instruction from the computer and, in response to the instruction, activate at least some of the individually controllable lights in order to create a first one of the plurality of programmed patterns, wherein the instruction does not identify which particular lights of the individually controllable lights are to be activated.

14. The configurable headlight indicator system of claim 12 further comprising a computer coupled to the at least one controller, and wherein the at least one controller is configured to receive an instruction from the computer and, in response to the instruction, activate at least some of the individually controllable lights in order to create a first one of the plurality of programmed patterns, wherein the instruction identifies which particular lights of the individually controllable lights are to be activated.

15. The configurable headlight indicator system of claim 10 further comprising a support structure having a cavity formed therein to contain at least a portion of the configurable indicator array, wherein the cavity is covered by the cover.

16. The configurable headlight indicator system of claim 15 wherein the support structure includes a bezel having the first and second supports formed therein, wherein the first support retains a projection light and the second support retains the configurable indicator array.

17. A configurable headlight indicator system comprising:
a support structure having a cavity defined therein and first and second supports positioned at least partially within the cavity;
a projection light retained in the support structure at least in part by the first support;
a cover having first and second sides, wherein the cover at least partially reflects external light striking the first side and wherein the cover is positioned over the cavity with the second side facing the cavity;
a light emitting diode (LED) array having a plurality of individually controllable LEDs positioned at least partially within the cavity and retained at least in part by the second support, wherein the LED array is oriented to shine through the second and first sides of the cover; and
a controller configured to activate and deactivate the individually controllable LEDs to create one of a plurality of programmed patterns representing a visual indicator.

18. The configurable headlight indicator system of claim 17 wherein the controller is configured to activate the individually controllable LEDs to simultaneously create two or more of the plurality of programmed patterns.

19. The configurable headlight indicator system of claim 17 further comprising a computer coupled to the at least one controller, wherein the at least one controller is configured to receive an instruction from the computer and, in response to the instruction, activate at least some of the individually controllable LEDs to create a first one of the plurality of programmed patterns.

20. The configurable headlight indicator system of claim 17 wherein the second support is a curved channel extending at least partially around an edge of the support structure and wherein the LED array is positioned within the curved channel.
